(19) United States
(12) Patent Application Publication
(10) Pub. No.: US 2005/0141567 A1
(43) Pub. Date: Jun. 30, 2005

(54) Extending Ethernet-over-SONET to provide point-to-multipoint service

(76) Inventors: Abed Jaber, Plano, TX (US); David Michael Colven, Dallas, TX (US); Li-Chang Janet Lin, New Hempstead, NY (US); Ted D. Chang, Richardson, TX (US); Edward A. Harbin, Dallas, TX (US)

Correspondence Address: SWIDLER BERLIN LLP, 3000 K STREET, NW, BOX IP, WASHINGTON, DC, 20007, US

(21) Appl. No.: 10/745,633

(22) Filed: Dec. 29, 2003

(51) Int. Cl. H04J 3/02

(52) U.S. Cl. 370/537

(57) ABSTRACT

An apparatus extends Ethernet-over-SONET services to provide point-to-multipoint service. Multiple optical channels are aggregated to form a single high speed channel to an attached router or switch. A traffic aggregation/trunking apparatus for a telecommunications system comprises a plurality of client data communication ports operable to communicate data traffic with client systems, a trunk port operable to communicate data traffic with a switch/router, and a processing block operable to process the communicated data traffic.

### FIELD OF THE INVENTION

The present invention relates to a telecommunications system that Ethernet Trunking and Ethernet Aggregation of Ethernet-over-SONET service to provide point-to-multipoint service.

### BACKGROUND OF THE INVENTION

As data communication services have expanded, a number of technological issues have arisen. A common service that is implemented is the provision of Wide Area Networks (WANs) and Local Area Networks (LANs) over telecommunications equipment. For example, Ethernet-Over-SONET (EOS) network services may be provided. In a conventional implementation, such as that shown in FIG. 1, only point-to-point EOS is used to provide service to a plurality of service subscribers/clients 102. The connections to service subscribers/clients 102 are provided by 10/100BaseT Ethernet services 104. In order to communicate the data traffic to/from subscribers/clients 102 over high capacity trunks, the data traffic is aggregated. For example, the 10/100BaseT traffic channels 104 are time division multiplexed (TDM) by data multiplexers 106 onto a plurality of OC-3 channels 107. The traffic on the OC-3 channels is aggregated at traffic aggregator 108 and communicated with switch/router 110, which is connected to a high speed trunk. In the conventional system shown in FIG. 1, the communication between traffic aggregator 108 and switch/router 110 is provided by a plurality of relatively low bandwidth channels, such as 10/100BaseT channels 112. Such an arrangement requires a large number of ports on both traffic aggregator 108 and switch/router 110, which greatly increases the cost. A need arises for a technique by which multiple subscriber/client data traffic can be aggregated and trunked more efficiently and at reduced cost compared to conventional techniques.

### SUMMARY OF THE INVENTION

T-PORT is a mode of operation whereby 24 STS-1 channels are aggregated to form an interface to an attached router or switch, such as Gigabit Ethernet (GigE) or 10/100 BaseT Ethernet interface. The goal of T-PORT is to provide low cost Ethernet service approaching the costs of DS-3. In general, T-PORT models an Ethernet interface as an OC-24 channelized with some common LAN side attributes and multiple WAN side objects. Each of the WAN side objects represents an EOS service terminated at an EOS service. Multiplexing and de-multiplexing of different EOS traffic is done via LAN side negotiated VLAN IDs (VC labels). VLAN tags are stripped at the T-PORT for all ingressing traffic before sending it to remote EOS. Egressing LAN frames are tagged (i.e. VC tags) before sent out the LAN side.

In one embodiment of the present invention, a traffic aggregation/trunking apparatus for a telecommunications system comprises a plurality of client data communication ports operable to communicate data traffic with client systems, a trunk port operable to communicate data traffic with a switch/router, and a processing block operable to process the communicated data traffic.

In one aspect of the present invention, the processing block is operable to add a virtual local area network ID to a packet received at a client data communication port. The processing block may be further operable to route a packet received at the trunk port to a client data communication port based on a virtual local area network ID included in the packet received and remove the virtual local area network ID from the packet before communicating the packet to the routed client data communication port. Each client data communication port may have an associated port ID. The virtual local area network ID added to a packet received at a client data communication port may be based on the associated port ID of the client data communication port. The plurality of client data communication ports may be Ethernet-over-SONET ports. The trunk port may be a high-speed data port operable to communicate data with a switch/router. The high-speed data port may be a Gigabit Ethernet port or a 10/100 BaseT Ethernet port.

In one aspect of the present invention, the processing block is operable to receive a packet including a virtual local area network ID at a client data communication port. The processing block may be further operable to route a packet received at the trunk port to a client data communication port based on a virtual local area network ID included in the packet received. Each client data communication port may have an associated port ID. The virtual local area network ID added to a packet received at a client data communication port may be based on the associated port ID of the client data communication port. The plurality of client data communication ports may be Ethernet-over-SONET ports. The trunk port may be a high-speed data port operable to communicate data with a switch/router. The high-speed data port may be a Gigabit Ethernet port or a 10/100 BaseT Ethernet port.

In one embodiment of the present invention, a traffic aggregation/trunking apparatus for a telecommunications system comprises a plurality of client data communication ports operable to communicate data traffic with client systems, an aggregation port operable to communicate data traffic with a switch/router, and a processing block operable to process the communicated data traffic.

In one aspect of the present invention, the processing block is operable to add a virtual local area network ID to a packet received at a client data communication port. The processing block may be further operable to route a packet received at the aggregation port to a client data communication port based on a virtual local area network ID included in the packet received and remove the virtual local area network ID from the packet before communicating the packet to the routed client data communication port. Each client data communication port may have an associated port ID. The virtual local area network ID added to a packet received at a client data communication port may be based on the associated port ID of the client data communication port. The plurality of client data communication ports may be Ethernet ports. The aggregation port may be a high-speed data port operable to communicate data with a switch/router. The high-speed data port may be a Synchronous Optical Network/Synchronous Digital Hierarchy port.

In one aspect of the present invention, the processing block is operable to receive a packet including a virtual local area network ID at a client data communication port. The processing block may be further operable to route a packet received at the aggregation port to a client data communication port based on a virtual local area network ID included in the packet received. Each client data communication port may have an associated port ID. The virtual local area network ID added to a packet received at a client data communication port may be based on the associated port ID of the client data communication port. The plurality of client data communication ports may be Ethernet ports. The aggregation port may be a high-speed data port operable to communicate data with a switch/router. The high-speed data port may be a Synchronous Optical Network/Synchronous Digital Hierarchy port.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is a block diagram of a prior art system incorporating only point-to-point Ethernet-Over-SONET services.

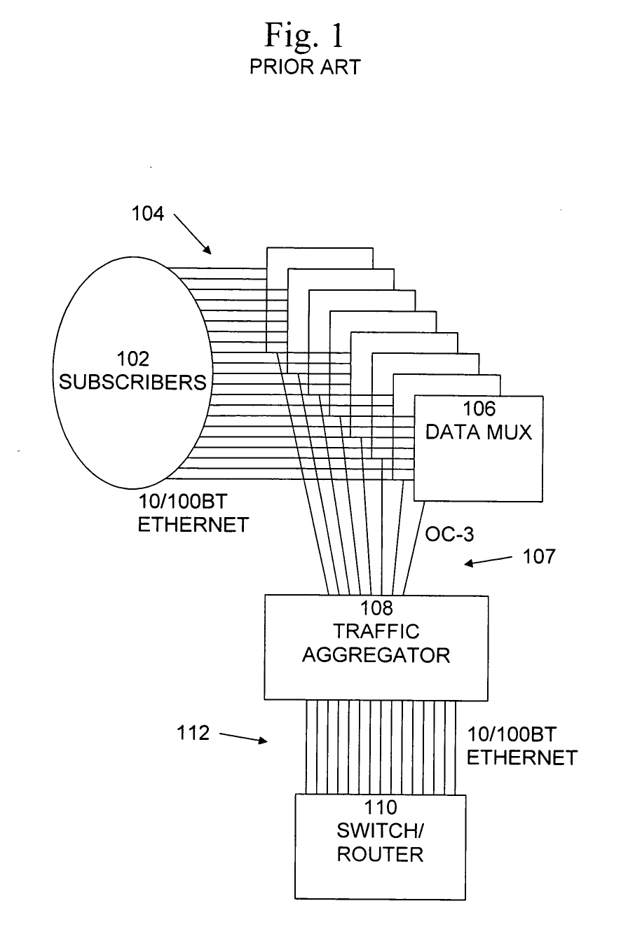

FIG. 2 is an exemplary block diagram of a system incorporating the point-to-multipoint service of the present invention.

FIG. 3 is an exemplary block diagram of an Ethernet trunking function performed in the system shown in FIG. 2.

FIG. 4 is an exemplary diagram of Ethernet Trunking Port operation in the system shown in FIGS. 2 and 3.

FIG. 5 is an exemplary diagram of Ethernet Trunking Port operation with VLAN transparency in the system shown in FIGS. 2 and 3.

FIG. 6 is an exemplary block diagram of a system incorporating an Ethernet aggregation function.

FIG. 7 is an exemplary diagram of Ethernet Aggregation Port operation in the system shown in FIG. 6.

FIG. 8 is an exemplary diagram of Ethernet Aggregation Port operation with VLAN transparency in the system shown in FIG. 6.

FIG. 9 is an exemplary block diagram of a telecommunications network incorporating Ethernet Trunking that is compatible with the TIRKS system.

FIG. 10 is an exemplary block diagram of a telecommunications network incorporating Ethernet Trunking and Ethernet Aggregation that is compatible with the TIRKS system.

FIG. 11 includes exemplary block diagrams of telecommunications networks incorporating Ethernet Trunking and Ethernet Aggregation that are compatible with the TIRKS system.

FIG. 12 is an exemplary flow diagram of a process of provisioning network elements to configure Ethernet Trunking.

FIG. 13 is an exemplary block diagram of the performance of the process shown in FIG. 12.

### DETAILED DESCRIPTION OF THE INVENTION

The present invention is a system and method that provides the capability to aggregate and trunk multiple subscriber/client data traffic more efficiently and at reduced cost compared to conventional techniques. In general, the present invention models an Ethernet interface as an OC-24 channelized with some common Local Area Network (LAN) side attributes and multiple Wide Area Network (WAN) side objects. Each of the WAN side objects represents an Ethemet-Over-SONET (EOS) service terminated at an EOS service. Multiplexing and de-multiplexing of different EOS traffic is done via LAN side negotiated Virtual LAN (VLAN) IDs (VC labels). Identifiers such as VLAN tags, MPLS labels, etc. are stripped or policed at the T-PORT for all ingressing traffic before it is sent to remote EOSs. Egressing LAN frames are tagged (for example with. VC tags) before they are sent out the LAN side.

The present invention advantageously provides a cheaper Ethernet-based alternative to the optical handoff in common use today. In addition the present invention advantageously provides a Telcordia management model for a channelized Ethernet interface in a TDM like solution and extends EOS to cover point-to-multipoint service offering by leveraging EOS point-to-point services.

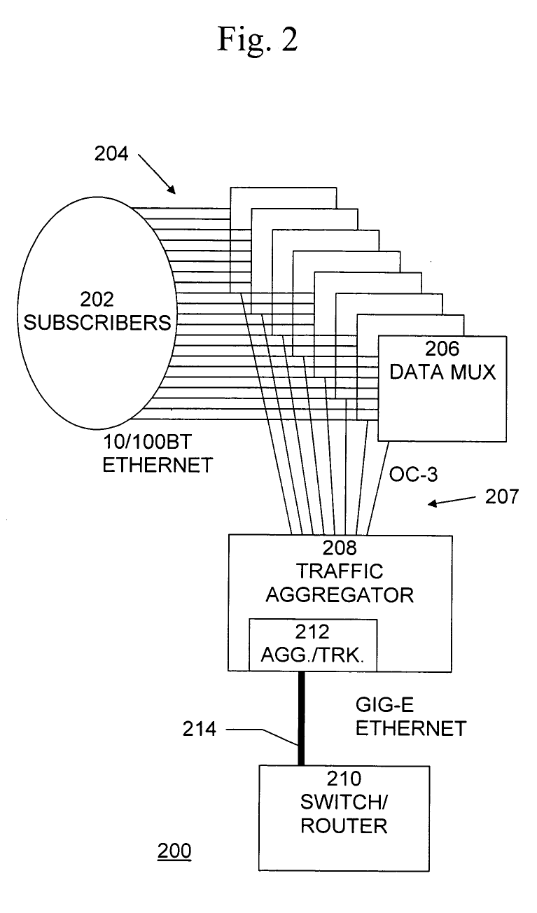

An exemplary embodiment of a system 200 incorporating the present invention is shown in FIG. 2. The connections to service subscribers/clients 202 are provided by 10/100BaseT Ethernet services 204. In order to communicate the data traffic to/from subscribers/clients 202 over high capacity trunks, the data traffic is aggregated. For example, the 10/100BaseT traffic channels 204 are time division multiplexed (TDM) by data multiplexers 206 onto a plurality of OC-3 channels 207. The traffic on the OC-3 channels is aggregated at traffic aggregator 208 and communicated with switch/router 210, which is connected to a high speed trunk. Traffic aggregator 208 includes aggregation/trunking block 212, which provides Ethernet trunking of data that is communicated with switch/router 210 over a high-speed data link, such as Gigabit Ethernet (GigE) or a 10/100 BaseT Ethernet link 214.

Among the technologies that may be used to implement the present invention are optical technologies, such as Synchronous Optical Network (SONET) and Synchronous Digital Hierarchy (SDH). SONET is a standard for connecting fiber-optic transmission systems. SONET was proposed by Bellcore in the middle 1980s and is now an ANSI standard. SONET defines interface standards at the physical layer of the OSI seven-layer model. The standard defines a hierarchy of interface rates that allow data streams at different rates to be multiplexed. SONET establishes Optical Carrier (OC) levels from 51.8 Mbps (about the same as a T-3 line) to 2.48 Gbps. Prior rate standards used by different countries specified rates that were not compatible for multiplexing. With the implementation of SONET, communication carriers throughout the world can interconnect their existing digital carrier and fiber optic systems.

SDH is the international equivalent of SONET and was standardized by the International Telecommunications Union (ITU). SDH is an international standard for synchronous data transmission over fiber optic cables. SDH defines a standard rate of transmission at 155.52 Mbps, which is referred to as STS-3 at the electrical level and STM-1 for SDH. STM-1 is equivalent to SONET's Optical Carrier (OC) levels −3.

In this document, a number of embodiments of the present invention are described as incorporating SONET. Although, for convenience, only SONET embodiments are explicitly described, one of skill in the art would recognize that all such embodiments may incorporate SDH and would understand how to incorporate SDH in such embodiments. Therefore, wherever SONET is used in this document, the use of either SONET or SDH is intended and the present invention is to be understood to encompass both SONET and SDH.

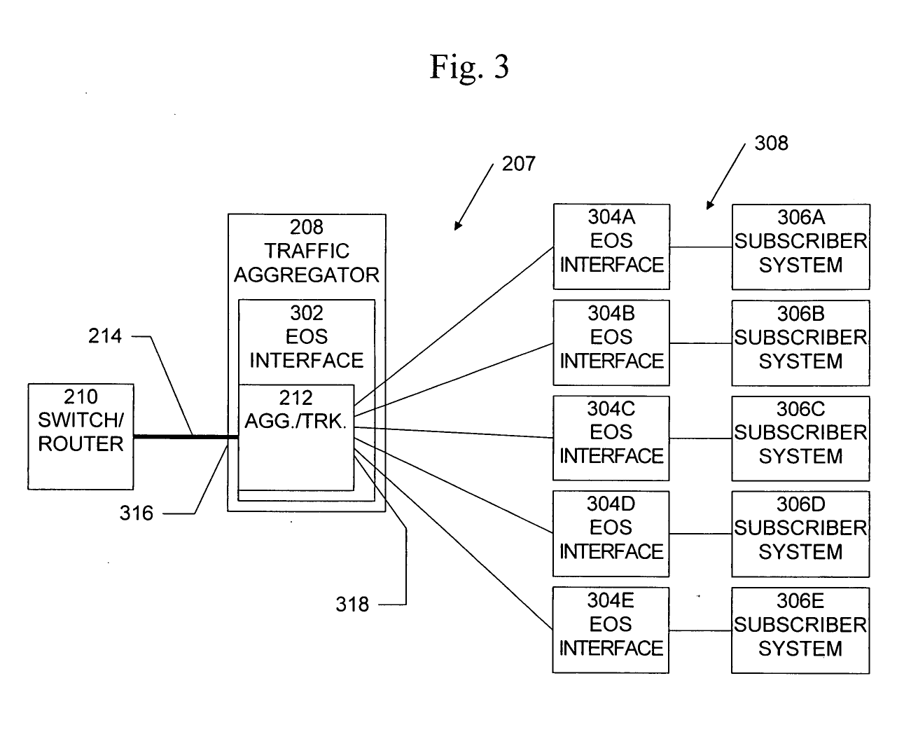

An exemplary block diagram of the Ethernet trunking function performed in system 200 is shown in FIG. 3. Switch/router 210 communicates over a high-speed data link, such as Gigabit Ethernet (GigE) or a 10/100 BaseT Ethernet link 214, with traffic aggregator 208. Traffic aggregator 208 includes EOS interface 302, which includes aggregation/trunking block 212. Traffic aggregator 208 communicates data using the Ethernet-Over-SONET communication protocol, which is implemented by EOS interface 302 on the network side and EOS interfaces 304A-E on the subscriber/client side. EOS interface 302 communicates over a plurality of SONET channels, such as OC-3 channels 207. Each OC-3 channel 207 includes N STS-1 channels. OC-3 channels 207 communicate data with EOS interfaces 304A-E, which then communicate the data with subscriber/client systems 306A-E, respectively, using a standard networking protocol channel, such as 10/100BaseT Ethernet channels 308.

Aggregation/trunking block 212 performs TDM-like Ethernet multiplexing to aggregate data to/from multiple relatively low utilization, relatively low speed Ethernet channels into a relatively high utilization, relatively high speed Ethernet channel, such as GigE or a 10/100 BaseT channel 214. This embodiment prevents or reduces over-subscription and requires no statistical multiplexing. It is preferably transparent to the subscriber/client network and requires no STP or VLAN participation. It is compatible with OSMINE provisioning as it may be managed like an Ethernet port command. For example, a GigE port can be viewed (provisioned) as an OC-24 port in which each STS path fans out to a different remote Ethernet port, as shown in FIG. 3. Likewise, a 10/100 BaseT Ethernet port can be provisioned as an appropriate SONET port.

Aggregation/trunking block 212 performs what may be terms an “Ethernet Trunking” function. One Ethernet Trunking entity consists of one Ethernet Trunk port (EOS/T-PORT) or “LAN port” 316, connected to GigE or10/100 BaseT channel 214, and multiple client ports or “WAN ports” 318, connected to OC-3 channels 207. EOS/T-PORT Ethernet Trunk port 316 should be provisioned with a bandwidth equal to an equivalent SONET/TDM port. For example, a GigE Ethernet port should be provisioned as an OC-24 SONET port and a 100BaseT port should be provisioned as an OC-2 SONET port. The sum of WAN ports 318 bandwidth should be less or equal than the EOS/T-PORT Ethernet Trunk port 316 bandwidth. Layer 1 Rate Limit/Adaptation is performed per each STS channel carried by each OC-3 channel. WAN ports 318 should support STS virtual concatenation. Preferably, each Trunking entity should support 24 WAN ports 318, where sum of the all WAN ports 318 bandwidth is not greater than 24 STS-1s.

Additional desirable features of a system incorporating EOS/T-PORT Ethernet Trunk port 316 may include: no Bridging/switching should be required, no VLAN function provisioning other than Ethernet Trunk port (EPORT-like) should be required, the EOS/T-PORT function may be compatible with OSMINE, and EOS/T-PORT may provide per VLAN accounting as Layer 1 accounting.

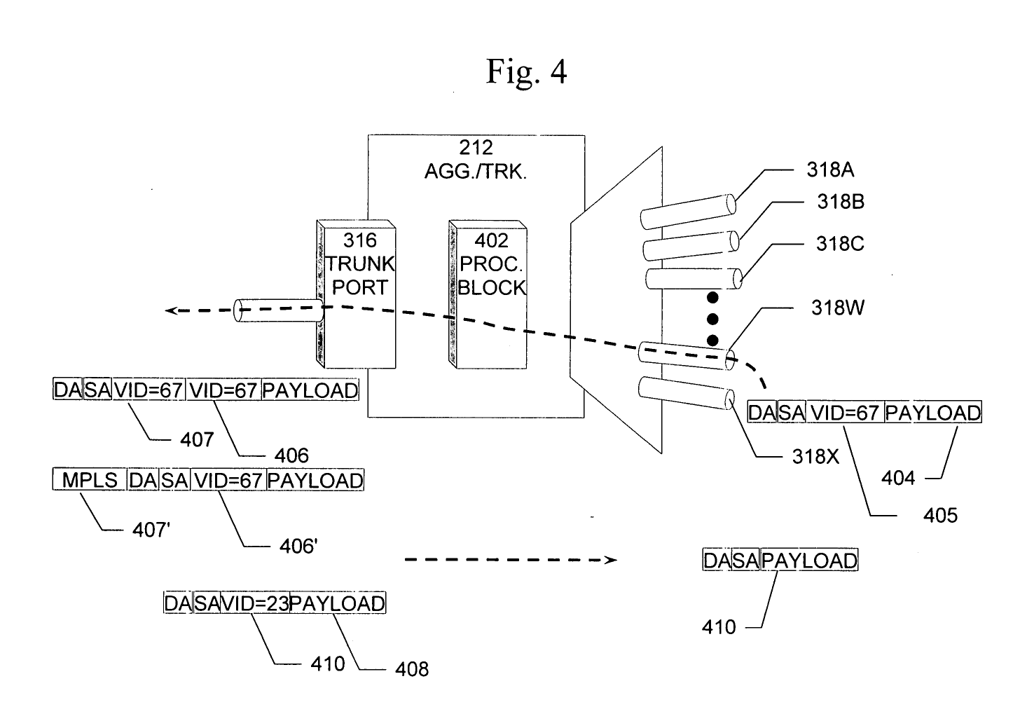

An example of Ethernet Trunking Port operation in the system shown in FIGS. 2 and 3 is shown in FIG. 4. As shown in FIG. 4, client EOS ports 318A-X connect through STS paths. Each client EOS port 318A-X has an associated Port ID (PID). For MAC packets received at client EOS ports 318A-X, such as packet 404, the subscriber switch adds a Virtual LAN (VLAN) ID (VID) 405 The packet is communicated by aggregation/trunking block 212 to trunk port 316. Trunk port 316 adds another identifier that is based on the PID and which is auto-assigned based on the timeslot allocated to the port on which the MAC packet is received. The identifier may be, for example in packet 406, a second VID 407, or the identifier may be, for example in packet 406′, MPLS label 407′. The VID is used by the device, such as a switch/router that is connected to trunk port 316 in order to perform flow ID functions. A Customer Activation State is used on each STS path to enable service.

Likewise, for MAC packets received at trunk port 316, such as packet 408, each packet includes a VID 410 that is based on the PID of the client EOS port to which the MAC packet is destined. VID 410 is policed or added if it is not present in the received packet. The packet is routed by aggregation/trunking block 212 from trunk port 316 to the appropriate client EOS port based on the included VID 410. In addition, aggregation/trunking block 212 removes the VID from the MAC packet before it is transmitted by the client EOS port.

Optionally, the packet 408 received at trunk port 316 may be discarded if the data traffic bandwidth is above the combined rate limit of the client EOS ports 318A-X. As one of skill in the art would recognize, 24 STS-1 channels of the client EOS ports 318A-X provide a maximum total data traffic bandwidth of approximately 1.25 Gbps, which is significantly greater than the bandwidth provided by a Gigabit Ethernet channel. When the combined data traffic bandwidth on the client EOS ports 318A-X exceeds the bandwidth provided by the Gigabit Ethernet channel, rate limiting must be performed. Preferably, this rate limiting is performed by use of a fairness algorithm, which allows each STS-1 channel to get a fair shot at placing its bandwidth on the GigE interface. If the SONET side bandwidth remains oversubscribed for a long enough period of time, frames will be dropped at the Rx buffer. This algorithm also insures that the frames are dropped fairly for each STS-1 channel, as well.

Preferably, the algorithm is implemented internal to an FPGA to provide the fair distribution of dropped traffic. The algorithm is used in conjunction with an external memory, which is divided into 24 pieces to store each STS-1 channel's traffic. The memory is hard partitioned to guarantee a fair amount of memory allocated to each channel. A token-based approach is used, where tokens are spent upon Ethernet frame transmission for each STS-1 channel and replenished periodically on a set time schedule. If an STS-1 channel has enough tokens it is allowed to transmit data onto the Ethernet port. If an STS-1 doesn't have enough available tokens, then it must wait until a predetermined threshold of tokens is exceeded. STS-1 channels are cycled through in a round robin fashion. Those channels that have enough tokens are allowed to transmit. The size of the frames sent determines the number of tokens that are removed from a particular STS-1 channel's token store. So, the algorithm maintains fairness despite the variations in Ethernet frame sizes from 64 bytes to 9216 bytes.

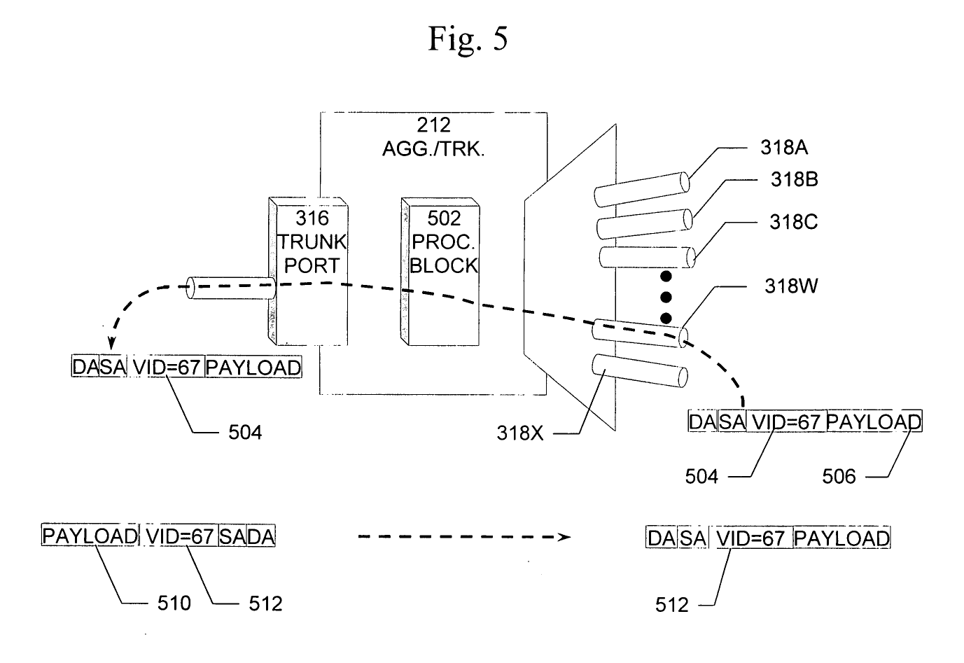

An example of Ethernet Trunking Port operation with VLAN transparency in the system shown in FIGS. 2 and 3 is shown in FIG. 5. As shown in FIG. 5, client EOS ports 318A-X connect through STS paths. VID 504 is assigned by the subscriber/client switch to each MAC packet 506 transmitted from the subscriber/client switch. The processing block 502 behaves like a VLAN switch and learns the VLAN ID from the client port, such as port 318W, that receives packet 506. The packet is communicated by aggregation/trunking block 212 to trunk port 316 without alteration. The VID is used by a device, such as a Level 2 (L2) Switch that is connected to trunk port 316 in order to perform flow ID functions.

Likewise, for MAC packets received at trunk port 316, such as packet 508, each packet includes a VID 510 that identifies the destination of the MAC packet. The packet is communicated by aggregation/trunking block 212 from trunk port 316 to the appropriate client EOS port based on the included VID 510. Optionally, the packet 510 received at trunk port 316 may be discarded if the data traffic bandwidth is above the combined rate limit of the client EOS ports 318A-X. In addition, GVRP snooping may be supported, but not as peer.

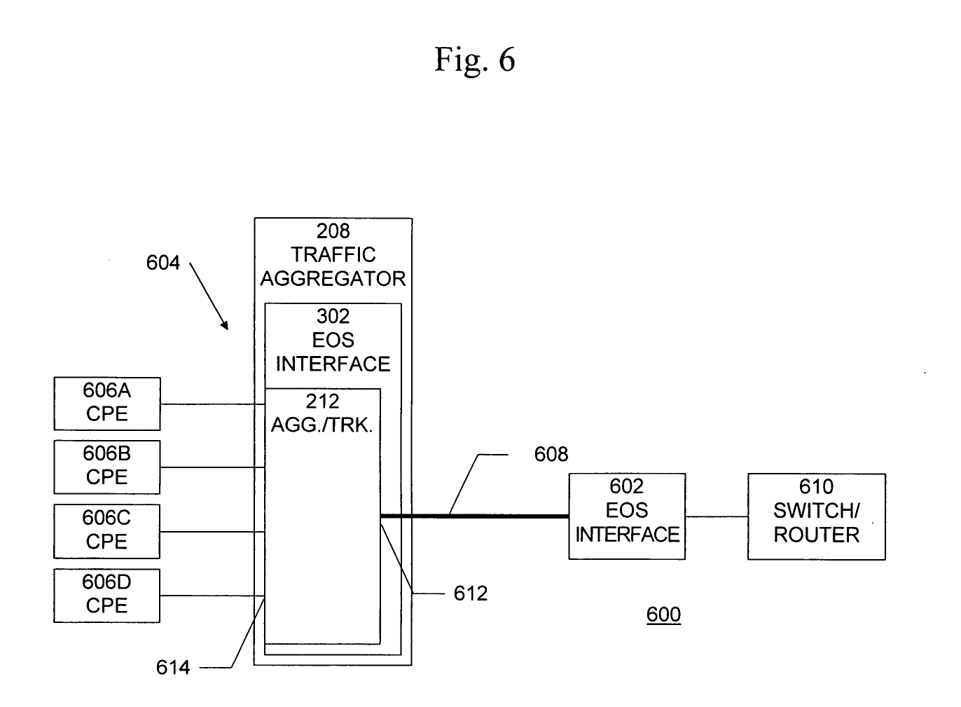

An exemplary block diagram of a system 600 incorporating an Ethernet aggregation function is shown in FIG. 6. Switch/router 610 communicates over a high-speed data link, such as Gigabit Ethernet (GigE) or10/100 BaseT link, with traffic aggregator 208. Traffic aggregator 208 includes EOS interface 302, which includes aggregation/trunking block 212. Traffic aggregator 208 communicates data using the Ethernet-Over-SONET communication protocol which is implemented by EOS interface 302 on the subscriber/client side and EOS interfaces 602 on the network side. EOS interface 302 communicates over a plurality of Ethernet channels 604 with customer premises equipment (CPE) 606A-D. EOS interface 302 communicates over a SONET channel, such as SONET channel 608, which includes N STS-1 channels. SONET channel 608 communicates data with EOS interface 602, which then communicates the data with switch/router 610.

Aggregation/trunking block 212 performs TDM-like Ethernet multiplexing to aggregate data to/from multiple relatively low utilization, relatively low speed Ethernet channels into a relatively high utilization, relatively high speed SONET channel, such as SONET channel 608. This embodiment prevents or reduces over-subscription and requires no statistical multiplexing. It is preferably transparent to the subscriber/client network and requires no STP or VLAN participation. It is compatible with OSMINE provisioning as it may be managed like an Ethernet port command. For example, a 10/100BaseT Ethernet port can be viewed (provisioned) as an N VT-1.5 ports in which each STS path fans out to multiple 10/100BaseT Ethernet ports, as shown in FIG. 6.

Aggregation/trunking block 212 performs what may be terms an “Ethernet Aggregation” function. One Ethernet Trunking entity consists of one Ethernet Aggregation port (EOS/APORT) or “WAN port” 612, SONET channel 608, and multiple client ports or “LAN ports” 614, connected to 10/100BaseT Ethernet channels 604. Each EOS/APORT client port 612 should be provisioned with a bandwidth equal to an equivalent TDM port. For example, a 100BaseT Ethernet port should be provisioned as a DS-3 port and a 10BaseT Ethernet port should be provisioned as a DS-1 port. The sum of LAN ports 614 bandwidths should be less or equal than the EOS/APORT Ethernet Aggregation port 612 bandwidth, which may be, for example, STS-1, STS-3c, STS-12c, or STS-24vc. Each LAN port 614 preferably supports rate limiting.

Additional desirable features of a system incorporating EOS/APORT Ethernet Aggregation port 612 may include: no Bridging/switching should be required, no VLAN function provisioning other than Ethernet client port (EPORT-like) should be required, the EOS/APORT function may be compatible with OSMINE.

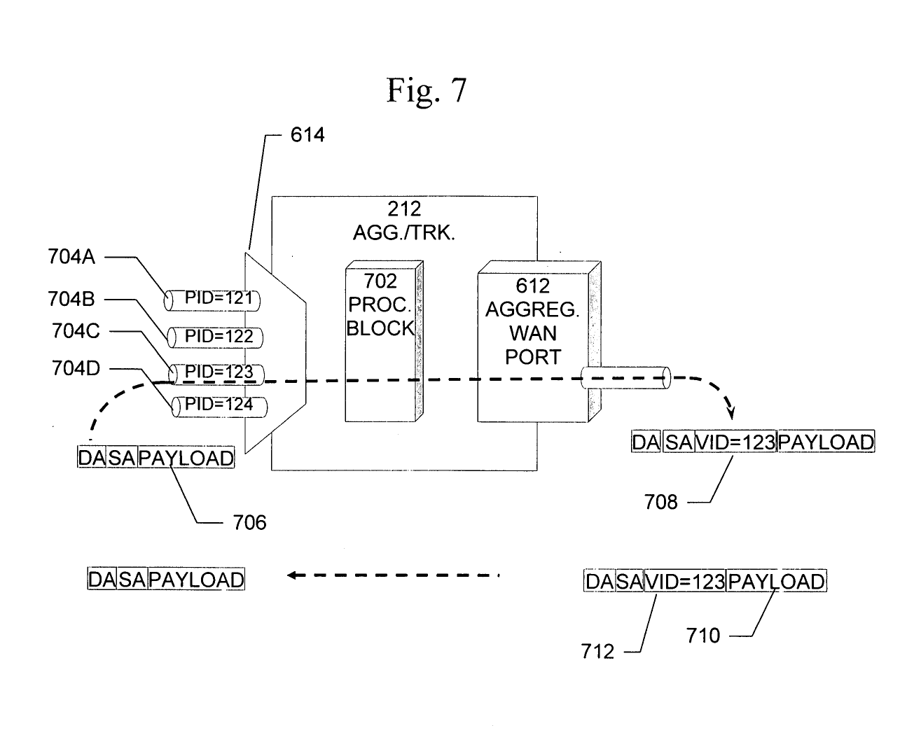

An example of Ethernet Aggregation Port operation in the system shown in FIG. 6 is shown in FIG. 7. As shown in FIG. 7, client Ethernet ports 704A-D connect to LAN ports 614. Each client Ethernet port has an associated Port ID (PID). For MAC packets received at client Ethernet ports 704A-D, such as packet 706, aggregation/trunking block 212 adds a Virtual LAN (VLAN) ID (VID) 708 that is based on the PID of the Ethernet port upon which the packet is received. The packet is communicated by aggregation/trunking block 212 to Aggregation WAN port 612. The VID is used by the device, such as a switch/router that is coupled to Aggregation WAN port 612 (via an EOS interface) in order to perform flow ID functions.

Likewise, for MAC packets received at Aggregation WAN port 612, such as packet 710, each packet includes a VID 712 that is based on the PID of the client Ethernet port to which the MAC packet is destined. The packet is communicated by aggregation/trunking block 212 from Aggregation WAN port 612 to the appropriate client Ethernet port based on the included VID 712. In addition, aggregation/trunking block 212 removes the VID from the MAC packet before it is transmitted by the client Ethernet port.

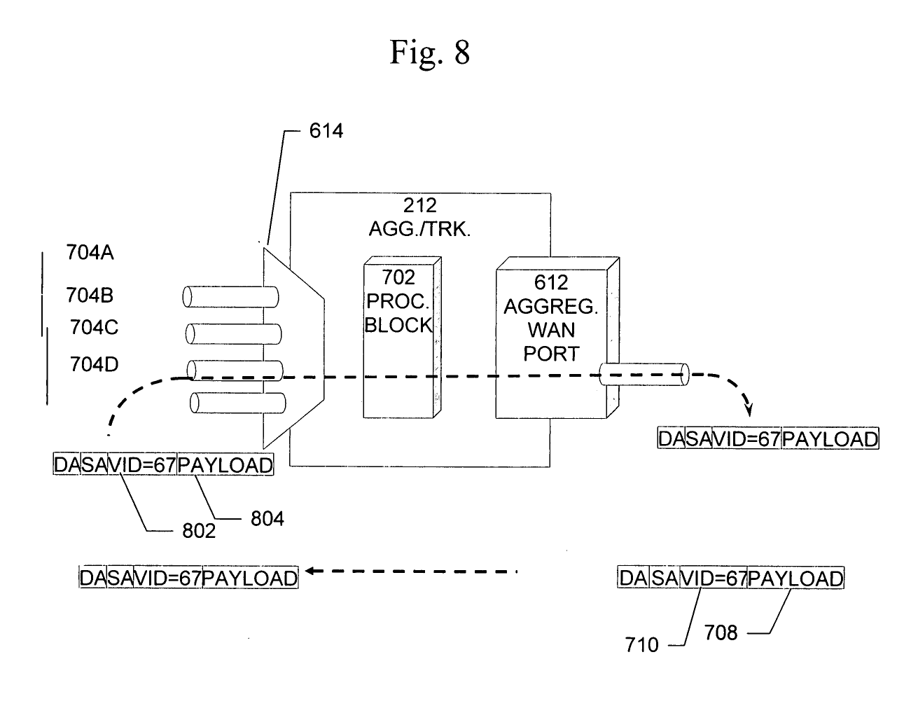

An example of Ethernet Aggregation Port operation with VLAN transparency in the system shown in FIG. 6 is shown in FIG. 8. As shown in FIG. 8. client Ethernet ports 704A-D connect to LAN ports 614. VID 802 is assigned by the subscriber/client switch to each MAC packet 804 transmitted from the subscriber/client switch. The processing block 702 behaves like a VLAN switch and learns the VLAN ID from the client port, such as port 704D, that receives packet 804. The packet is communicated by aggregation/trunking block 212 to Aggregation WAN port 612 without alteration. The VID is used by a device, such as a Level 2 (L2) Switch that is connected to Aggregation WAN port 612 in order to perform flow ID functions.

Likewise, for MAC packets received at Aggregation WAN port 612, such as packet 708, each packet includes a VID 710 that identifies the destination of the MAC packet. The packet is communicated by aggregation/trunking block 212 from Aggregation WAN port 612 to the appropriate client EOS port based on the included VID 710.

A standard service that is used to provision a SONET network is known as Operations Systems Modification of Intelligent Network Elements (OSMINE). Most domestic telecommunications networks depend on operations support systems (OSS) software developed and maintained by TELCORDIA™. The major local exchange carriers manage their networks using these systems. The Telcordia OSMINE Services process helps enable network equipment compatibility and interoperability with Telcordia OSSs. This helps to ensure operations systems automation, a requirement to provide Operation, Administration, Maintenance and Provisioning (OAM&P) of services in a timely fashion and on a volume basis. Since it is important to provision Dual Working mode under the OSMINE process, this must also be considered.

The Telcordia™ TIRKS®V System is an integrated system that supports the total network provisioning process for special service circuits, message trunks, and carrier circuits. It also provides inventory management of facilities and equipment. TIRKS software supports a full range of transmission technologies including: SONET self-healing rings and sophisticated SONET configurations; digital circuit hierarchy (DS0, DS1, DS3); analog voice circuits; and European digital hierarchy standards (SDH).

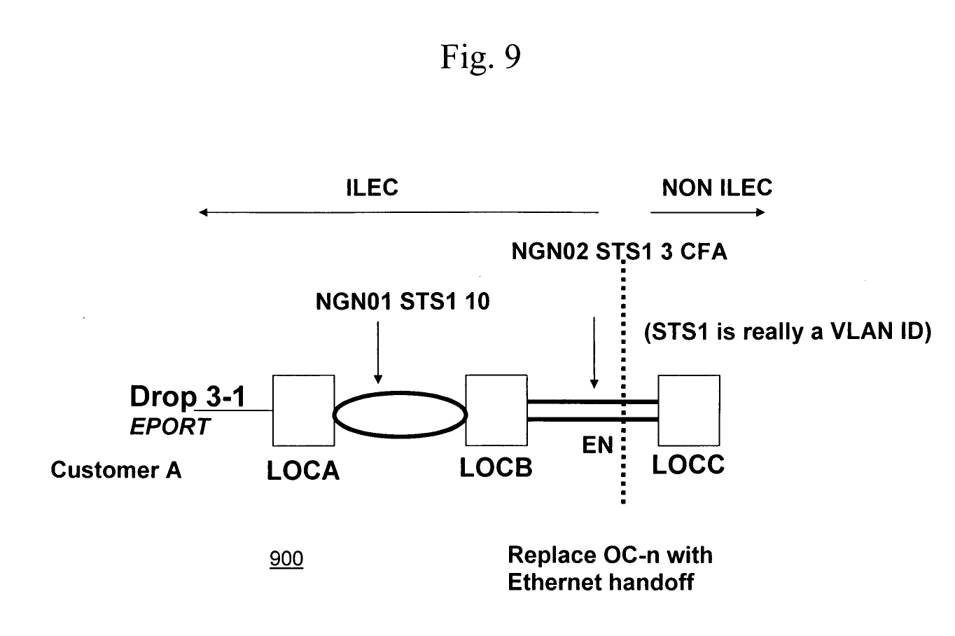

An exemplary block diagram of a telecommunications network 900 incorporating Ethernet Trunking that is compatible with the TIRKS system, is shown in FIG. 9. As shown in FIG. 9, a handoff from an Incumbent Local Exchange Carrier (ILEC) to a non-ILEC carrier is performed by system 900. The conventional handoff that is performed over an OC-n channel has been replaced with a handoff using an Ethernet Trunking (T-PORT) channel.

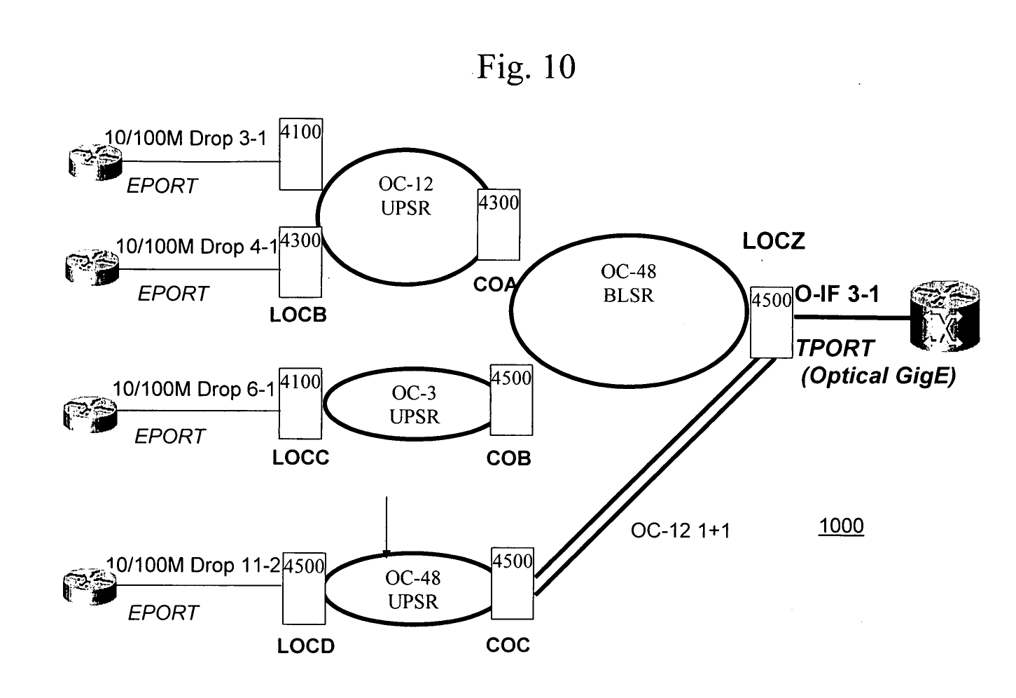

An exemplary block diagram of a telecommunications network 1000 incorporating Ethernet Trunking (T-PORT) and Ethernet Aggregation (EPORT) that is compatible with the TIRKS system, is shown in FIG. 10. As shown in FIG. 10, EPORT channels provide the link from subscribers/clients to the network, while a T-PORT channel provides the link from the network to the switch/router. Compatibility with TIRKS is provided by integrating EPORT commands into the TIRKS system.

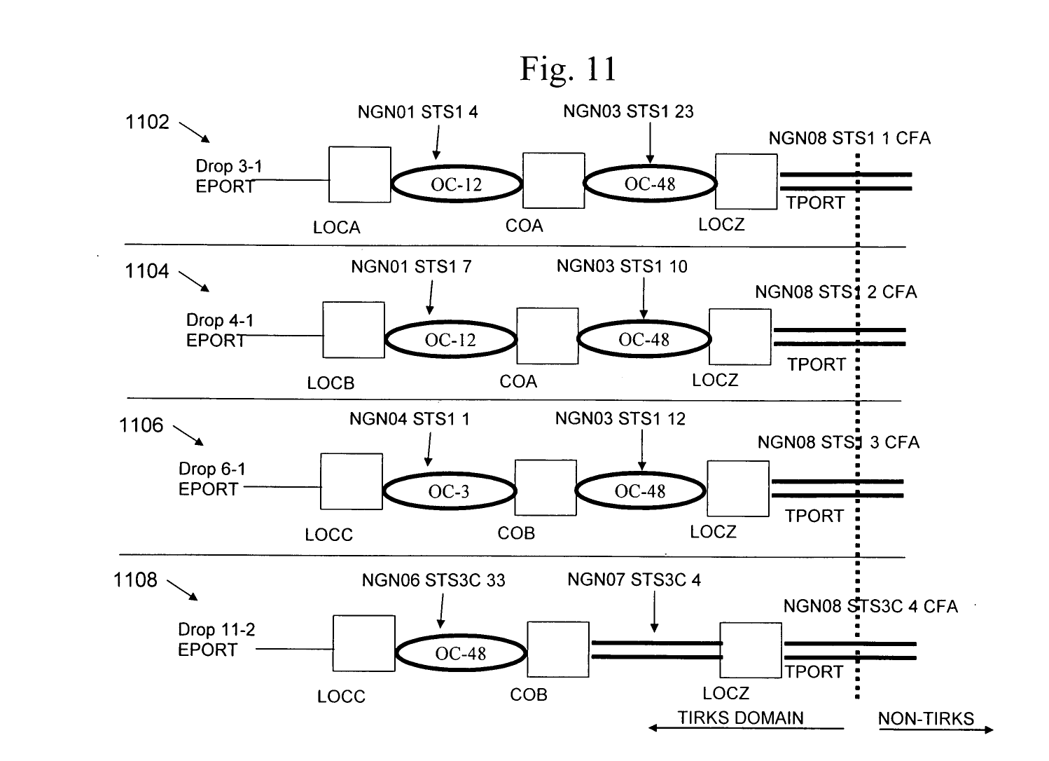

Exemplary block diagrams of telecommunications networks 1102, 1104, 1106, and 1108 incorporating Ethernet Trunking (T-PORT) and Ethernet Aggregation (EPORT) that are compatible with the TIRKS system, are shown in FIG. 11. As shown in FIG. 11, EPORT channels provide the links from subscribers/clients to the network over STS-1, while a T-PORT channel provides the link from the network to the switch/router. Compatibility with TIRKS is provided by integrating EPORT commands into the TIRKS system.

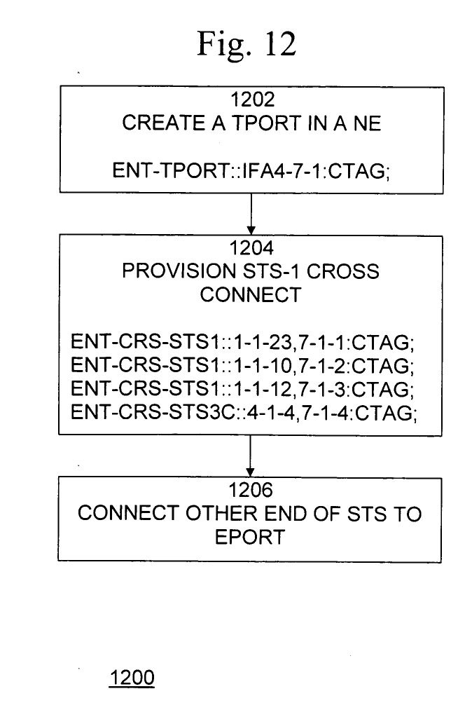

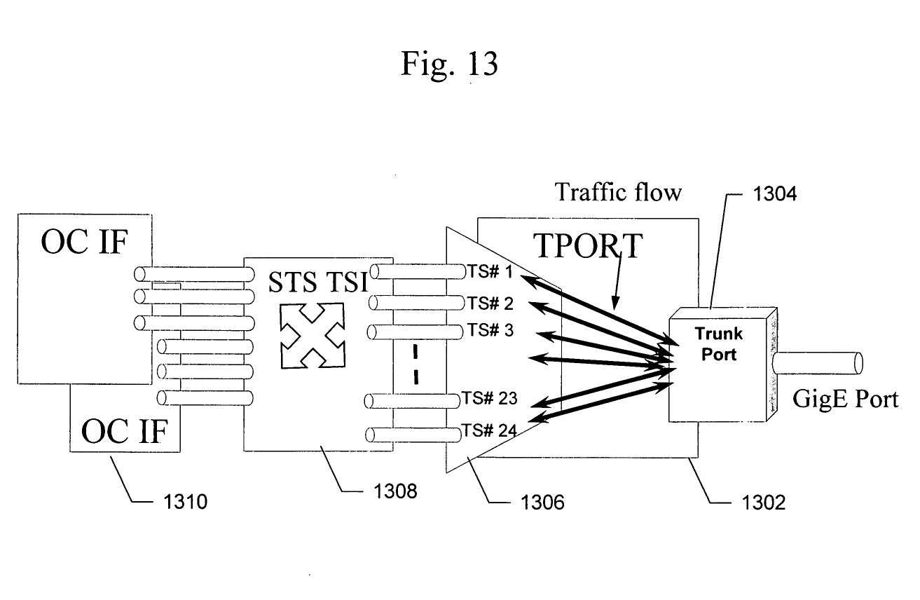

An exemplary flow diagram of a process 1200 of provisioning network elements to configure T-PORT is shown in FIG. 12. It is best viewed in conjunction with FIG. 13, which is an exemplary block diagram of the performance of process 1200. The process begins with step 1202, in which a T-PORT 1302 is created in a network element 1302. An example of a provisioning command that performs this step is:
ENT-T-PORT::IFA4-7-1:CTAG;

This exemplary command creates a T-PORT on interface slot #4, port #1. The keywords used are similar to ENT-EPORT command. In addition, the STS-1 ports 1306 are configured. For example, if the command WANLINK=STS24 is used, 24 STS-1 ports are configured and will be available for carrying Ethernet over SONET payload.

In step 1204, the STS cross connect is provisioned. An example of a provisioning commands that perform this step is:
ENT-CRS-STS 1::1-1-23,7-1-1:CTAG;
ENT-CRS-STS 1::1-1-10,7-1-2:CTAG;
ENT-CRS-STS 1::1-1-12,7-1-3:CTAG;
ENT-CRS-STS3C::4-1-4,7-1-4:CTAG;

In step 1206, the other end of the STS channels are connected to the EPORT via OC interfaces 1310.

Although specific embodiments of the present invention have been described, it will be understood by those of skill in the art that there are other embodiments that are equivalent to the described embodiments.

For example, as described above, T-PORT is a mode of operation whereby 24 STS-1 channels are aggregated to form an interface to an attached router or switch, such as Gigabit Ethernet (GigE) or 10/100 BaseT Ethernet interface. Alternatively, the interface may be a link aggregated bundle. In a link aggregated bundle, multiple physical ports are treated as an aggregated port. An example of such a port is specified by the well-known standard IEEE 802.3ad.

As another example, STS-1 channels are described on the WAN side. Alternatively, multiple virtually concatenated STS-1 channels may be used. For example, where a 10-BaseT Ethernet is to be carried over a single STS-1 channel, the STS-1 channel only provides about half of the traffic bandwidth that is needed. Likewise, where a 10-BaseT Ethernet is to be carried over a single STS-3c channel, significant traffic capacity of the STS-3c channel is wasted. Alternatively, two STS-1 channels may be used together by use of standard virtual concatentation (VCAT). In addition, the capacity and number of the channels used by the VCAT group may be dynamically adjusted using a standard link capacity-adjustment scheme (LCAS), such as that specified in the well-known standard ITU-T G.7042.

As another example, VLAN tags are described as being used to identify the source of traffic channels so that traffic can be properly separated on the T-PORT. However, standard Multi-Protocol Label Switching (MPLS) labels, such as those described in the well-known RFC-3031 document, may also be used to identify traffic for this purpose as well.

Accordingly, it is to be understood that the invention is not to be limited by the specific illustrated embodiments, but only by the scope of the appended claims.

1. A traffic aggregation/trucking apparatus for a telecomm-unications system comprising:
a plurality of client data communication ports operable to communicate data traffic with client systems;
a trunk port operable to communicate data traffic with a switch/router: and
a processing block operable to process the communicated data traffic.

2. The traffic aggregation/trunking apparatus of claim 1, wherein the processing block is operable to:
add a virtual local area network ID to a packet received at a client data communication port.

3. The traffic aggregation/trunking apparatus of claim 2, wherein the processing block is further operable to:
route a packet received at the trunk port to a client data communication port based on a virtual local area network ID included in the packet received; and
remove the virtual local area network ID from the packet before communicating the packet to the routed client data communication port.

4. The traffic aggregation/trunking apparatus of claim 3, wherein each client data communication port has an associated port ID.

5. The traffic aggregation/trunking apparatus of claim 4, wherein the virtual local area network ID added to a packet received at a client data communication port is based on the associated port ID of the client data communication port.

6. The traffic aggregation/trunking apparatus of claim 5, wherein the plurality of client data communication ports are Ethernet-over-SONET ports.

7. The traffic aggregation/trunking apparatus of claim 6, wherein the trunk port is a high-speed data port operable to communicate data with a switch/router.

8. The traffic aggregation/trunking apparatus of claim 7, wherein the high-speed data port is a Gigabit Ethernet or10/100 BaseT port.

9. The traffic aggregation/trunking apparatus of claim 1, wherein the processing block is operable to:
receive a packet including a virtual local area network ID at a client data communication port.

10. The traffic aggregation/trunking apparatus of claim 9, wherein the processing block is further operable to:
route a packet received at the trunk port to a client data communication port based on a virtual local area network ID included in the packet received.

11. The traffic aggregation/trunking apparatus of claim 10, wherein each client data communication port has an associated port ID.

12. The traffic aggregation/trunking apparatus of claim 11, wherein the virtual local area network ID added to a packet received at a client data communication port is based on the associated port ID of the client data communication port.

13. The traffic aggregation/trunking apparatus of claim 12, wherein the plurality of client data communication ports are Ethernet-over-SONET ports.

14. The traffic aggregation/trunking apparatus of claim 13, wherein the trunk port is a high-speed data port operable to communicate data with a switch/router.

15. The traffic aggregation/trunking apparatus of claim 14, wherein the high-speed data port is a Gigabit Ethernet or10/100 BaseT port.

16. A traffic aggregation/trunking apparatus for a telecommunications system comprising:
a plurality of client data communication ports operable to communicate data traffic with client systems;
an aggregation port operable to communicate data traffic with a switch/router; and
a processing block operable to process the communicated data traffic.

17. The traffic aggregation/trunking apparatus of claim 16, wherein the processing block is operable to:
add a virtual local area network ID to a packet received at a client data communication port.

18. The traffic aggregation/trunking apparatus of claim 17, wherein the processing block is further operable to:
route a packet received at the aggregation port to a client data communication port based on a virtual local area network ID included in the packet received; and
remove the virtual local area network ID from the packet before communicating the packet to the routed client data communication port.

19. The traffic aggregation/trunking apparatus of claim 18, wherein each client data communication port has an associated port ID.

20. The traffic aggregation/trunking apparatus of claim 19, wherein the virtual local area network ID added to a packet received at a client data communication port is based on the associated port ID of the client data communication port.

21. The traffic aggregation/trunking apparatus of claim 20, wherein the plurality of client data communication ports are Ethernet ports.

22. The traffic aggregation/trunking apparatus of claim 21, wherein the aggregation port is a high-speed data port operable to communicate data with a switch/router.

23. The traffic aggregation/trunking apparatus of claim 22, wherein the high-speed data port is a Synchronous Optical Network/Synchronous Digital Hierarchy port.

24. The traffic aggregation/trunking apparatus of claim 16, wherein the processing block is operable to:
receive a packet including a virtual local area network ID at a client data communication port.

25. The traffic aggregation/trunking apparatus of claim 24, wherein the processing block is further operable to:
route a packet received at the aggregation port to a client data communication port based on a virtual local area network ID included in the packet received.

26. The traffic aggregation/trunking apparatus of claim 25, wherein each client data communication port has an associated port ID.

27. The traffic aggregation/trunking apparatus of claim 26, wherein the virtual local area network ID added to a packet received at a client data communication port is based on the associated port ID of the client data communication port.

28. The traffic aggregation/trunking apparatus of claim 27, wherein the plurality of client data communication ports are Ethernet ports.

29. The traffic aggregation/trunking apparatus of claim 28, wherein the aggregation port is a high-speed data port operable to communicate data with a switch/router.

30. The traffic aggregation/trunking apparatus of claim 29, wherein the high- speed data port is a Synchronous Optical Network/Synchronous Digital Hierarchy port.
